(19) United States
(12) Patent Application Publication
(10) Pub. No.: US 2009/0087533 A1
(43) Pub. Date: Apr. 2, 2009

(54) AUTOMATIC DOUGHBALLER AND METHOD

(76) Inventors: Kurt Douglas Mertens, Colby, WI (US); Brian James Remus, Stratford, WI (US); Mark Robert Rinehart, Medford, WI (US); William Roger Doberstein, JR., Medford, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 12/239,125

(22) Filed: Sep. 26, 2008

Related U.S. Application Data
(60) Provisional application No. 60/995,664, filed on Sep. 27, 2007.

(51) Int. Cl. A21D 6/00; A21C 5/00

(52) U.S. Cl. 426/503; 425/145

(57) ABSTRACT

The present invention provides a dough dispensing system and a method of dispensing dough. In some embodiments, the method includes the acts of directing dough from a first plurality of dough receptacles to an adjacent second plurality of dough receptacles such that each one of the second plurality of dough receptacles receives dough from a corresponding one of the first plurality of dough receptacles, holding dough in the second plurality of dough receptacles until each of the second plurality of dough receptacles receives dough, and dispensing the dough from each of the second plurality of dough receptacles substantially simultaneously.

### RELATED APPLICATIONS

The present application claims the benefit of prior-filed, co-pending provisional patent application Ser. No. 60/995,664, filed Sep. 27, 2007.

### FIELD OF THE INVENTION

The present invention relates to apparatuses and methods for dispensing and maintaining the portion size of food products.

### SUMMARY

In some embodiments, the present invention provides an automatic doughball system operable to distribute doughballs on a conveyor. The distributed doughballs are then ready to be pressed into a desired shape adapted to receive pizza toppings.

The automatic doughball system of the present invention can allow for control of the rate and placement of the doughballs and can provide for an efficient method of placing doughballs on the conveyor to be fashioned into pizza crust. In other embodiments, the system and method of the present invention can be used to dispense and/or maintain the portion size of other food products.

In some embodiments, the present invention can provide an apparatus operable to distribute a number of similarly sized portions of food products along a conveyor. The apparatus can include a product monitoring system and timing system including at least one sensor and a programmable memory. The system can also include a distribution system for orienting the food products along the conveyor.

The present invention also provides a dough dispensing system including a first plurality of dough receptacles and a second plurality of dough receptacles. Each one of the second plurality of dough receptacles can be positioned adjacent to a corresponding one of the first plurality of dough receptacles to receive dough from the corresponding one of the first plurality of dough receptacles. The dough dispensing system can also include a diverter moveable relative to the first plurality of dough receptacles to direct the dough sequentially into each of the first plurality of dough receptacles. Each of the second plurality of dough receptacles can dispense dough substantially simultaneously.

In some embodiments, the present invention provides a dough dispensing system including a diverter moveable about a central axis to direct dough into each of a first plurality of dough receptacles, a second plurality of dough receptacles, each one of the second plurality of dough receptacles positioned adjacent to the first plurality of dough receptacles to receive dough from a corresponding one of the first plurality of dough receptacles, and a sensor associated with the second plurality of dough receptacles to determine whether at least one of the second plurality of dough receptacles contains dough and operable to delay dispense of dough from a corresponding one of the first plurality of dough receptacles until the at least one of the second plurality of dough receptacles is substantially dough-free.

The present invention also provides a method of dispensing dough. The method can include the acts of directing dough from a first plurality of dough receptacles to an adjacent second plurality of dough receptacles such that each one of the second plurality of dough receptacles receives dough from a corresponding one of the first plurality of dough receptacles and holding dough in the second plurality of dough receptacles until each of the second plurality of dough receptacles receives dough. The method can also include the act of dispensing the dough from each of the second plurality of dough receptacles substantially simultaneously.

Other aspects of the invention will become apparent by consideration of the detailed description and accompanying drawings.

### BRIEF DESCRIPTION OF THE DRAWINGS

FIG. 1 is a side view of an automatic doughball system according to some embodiments of the present invention.

FIG. 2 is a perspective view of a doughball placer module of the doughball system of FIG. 1.

FIG. 3 is a side view of the doughball placer module of FIG. 2.

FIG. 4 is a top view of the doughball placer module of FIG. 2.

FIG. 5 is a top view of an automatic doughball system according an alternate embodiment of the present invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

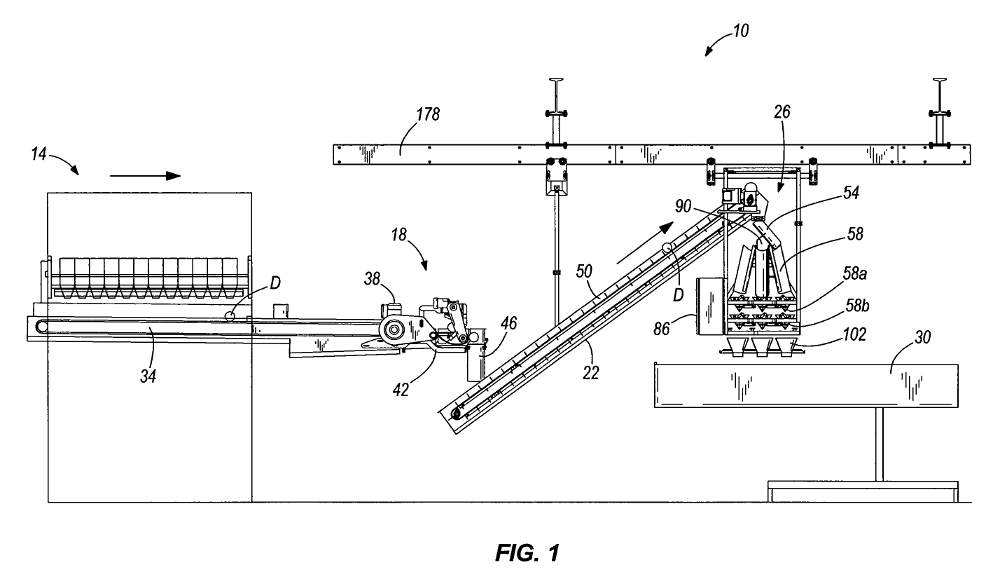

FIG. 1 illustrates an automatic doughball system 10 according to some embodiments of the present invention. While reference is made herein to a doughball dispensing system and to using the doughballs dispensed from the system 10 in the production of pizza, in alternative embodiments, the present invention can also or alternatively be used to dispense other food products or ingredients used in the production of other food products including, but not limited to, other baked goods (e.g., rolls, breadsticks, buns, cakes, cookies, etc.). In addition, while reference is made herein to upstream and downstream operations, it should be understood that the doughball system 10 of the present invention can be operated in-line with other upstream and downstream apparatuses, or alternatively, the doughball system 10 of the present invention can be operated as a stand alone system.

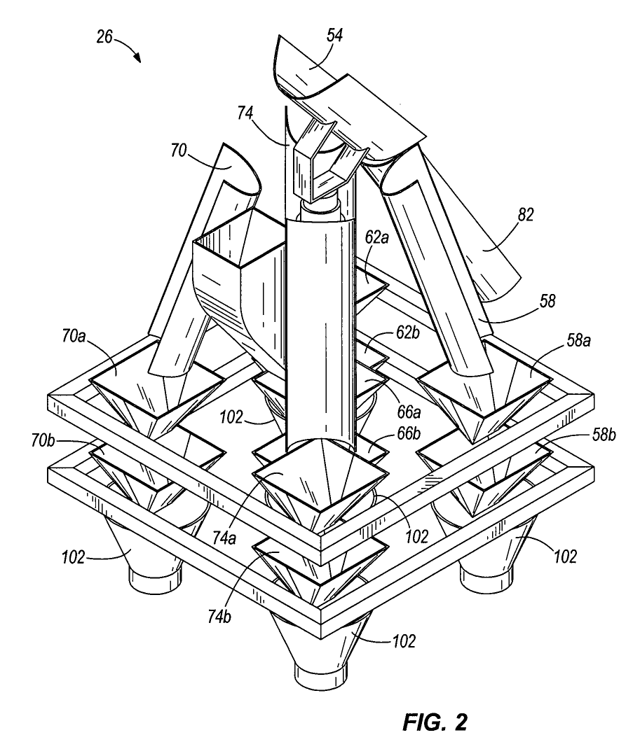

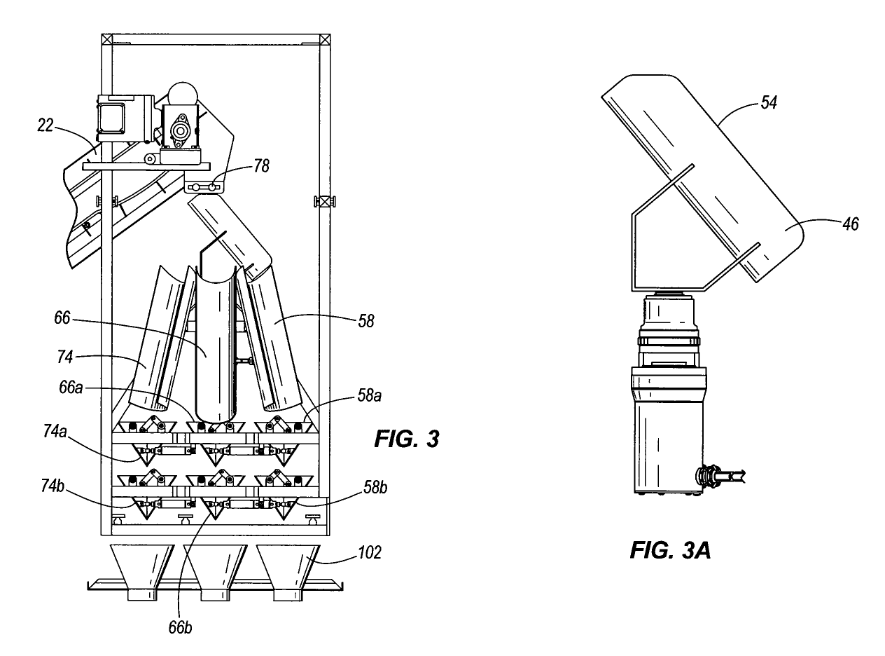

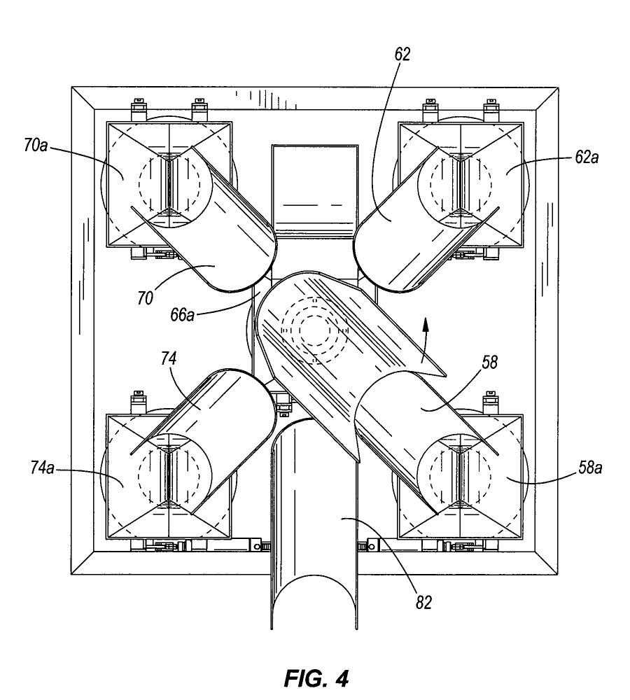

As shown in FIGS. 1-4, the automatic doughball system 10 can include a proofer 14, a checkweight module 18, a main conveyor 22, a doughball placer module 26, and a press conveyor 30 oriented along a linear or substantially linear dough travel path. In other embodiments, one or more of the proofer 14, the checkweight module 18, the main conveyor 22, and the doughball placer module 26, can have different relative orientations (i.e., non-linear, arcuate, U-shaped, etc.) to accommodate different doughball D processing speeds and/or different flow layout arrangements and plant arrangements (e.g., cellular manufacturing arrangements).

In the illustrated embodiment of FIGS. 1-4, the proofer 14 receives pizza dough from upstream elements and places individual doughballs D onto a feed conveyor 34. In the illustrated embodiment, the doughballs D are consistently sized and consistently shaped portions of pizza dough formed into a ball shape or other similarly shaped portion of dough. In other embodiments, the doughballs D can alternatively be dome-shaped, cylindrical, and the like. Accordingly, as used herein the term “doughball” includes portions of food product having a desired shape and size and is not limited to any particular shape or size.

During operation, the feed conveyor 34 transfers doughballs D to the checkweight module 18. In the illustrated embodiment of FIGS. 1-4, the checkweight module 18 includes a speed-up conveyor 38, a checkweigher 42, and a reject chute 46. The speed-up conveyor 38 can increase or decrease the feed speed of the doughballs D to downstream elements in response to the quantity of doughballs D traveling from the proofer 14 to the checkweight module 18 to maintain a desired spacing between adjacent doughballs D prior to weighing. The speed-up conveyor 38 can also or alternatively maintain and/or establish a uniform or substantially uniform distribution of doughballs D being feed to downstream elements. While reference is made herein to a “speed-up conveyor,” in some embodiments, the “speed-up conveyor 38 can also or alternatively be operable to slow down and/or change the travel direction of individual doughballs D.

The checkweigher 42 can weigh individual doughballs D to determine whether individual doughballs D are within a predetermined size range (i.e., whether the doughballs D are either under-size or over-size). The checkweigher 42 can also or alternatively identify double doughballs D. For instance, the checkweigher 42 can be pre-set for a certain weight to produce a specific size pizza crust. If the checkweigher 42 determines that the doughball D is either over or under the pre-set weight range, the reject chute 46 can transfer the doughball D to a reject bin. However, if the doughballs D are within the pre-set weight range, the doughballs D are placed on or directed toward the main conveyor 22.

In some embodiments, the predetermined size range can be adjusted so that the doughball system 10 can be used to produce doughballs D of different sizes. In some such embodiments, the doughball system 10 can produce a first run of doughballs D having a first size and/or shape and can then produce a second run of differently sized or shaped doughballs D. In this manner, the doughball system 10 can, for example, produce doughballs D for pizza crusts of a first size and a second different size. In still other embodiments, the doughball system 10 can produce a first run of doughballs D of a first recipe and can then produce a second run of doughballs D having a second recipe, and the doughballs D of the second recipe may or may not have the same weight as the doughballs D of the first recipe.

In the illustrated embodiment of FIGS. 1-4, the main conveyor 22 is a flighted conveyer that contains individual slots 50 sized for receipt of a single doughball D. The flighted main conveyor 22 provides for metered placement of the doughballs D into the doughball placer module 26. The flighted main conveyor 22 also maintains the individual doughballs D separated as they proceed to the doughball placer module 26.

The doughball placer module 26 of the illustrated embodiment of FIGS. 1-4 includes a rotary diverter chute 54, intermediate chutes 58, 62, 66, 70, 74, a series of upper level clamshell dough receptacles 58a, 62a, 66a, 70a, 74a, a series of lower level clamshell dough receptacles 58b, 62b, 66b, 70b, 74b, a photoeye or other position sensor 78, and an overflow chute 82. The rotary diverter chute 54 is a smooth, movable chute configured to convey doughballs D to the intermediate chutes 58, 62, 66, 70, 74.

While reference is made herein to upper and lower level receptacles having clamshell configurations, it should be appreciated that, in other embodiments, other dough receptacles, such as, for example, cup-shaped receptacles, tilting bucket-type receptacles, tray-type receptacles, and the like, can also or alternatively be used.

In the illustrated embodiment, there are five intermediate chutes 58, 62, 66, 70, 74 corresponding to each of five upper level clamshells 58a, 62a, 66a, 70a, 74a. The intermediate chutes 58, 62, 66, 70, 74 channel the doughballs D from the rotary diverter chute 54 to the respective upper level clamshells 58a, 62a, 66a, 70a, 74a. In the illustrated embodiment, the intermediate chutes 58, 62, 66, 70, 74 are stationary chutes positioned along a perimeter 86 of the doughball placer module 26. The five upper level and lower level clamshells 58a, 62a, 66a, 70a, 74a, 58b, 62b, 66b, 70b, 74b are labeled as stations one through five, respectively. The five lower level clamshells 58b, 62b, 66b, 70b, 74b correspond to each of the five upper level clamshells 58a, 62a, 66a, 70a, 74a, respectively. In other embodiments, there may be three, four, six, or more clamshells on a level or common plane. In the illustrated embodiment, for each upper level clamshell, there is an intermediate chute and a lower level clamshell. However, in other embodiments, there may be fewer intermediate chutes than upper level clamshells. There may also be no intermediate chutes, wherein the doughballs D are placed in the upper level clamshells directly by the rotary diverter chute. In the illustrated embodiment, the clamshell stations are arranged in a square orientation. However, the clamshell stations may be arranged in any orientation, such as rectangular, circular, triangular, and the like.

In some embodiments, the rotary diverter chute 54 has a home position; wherein the home position aligns the rotary diverter chute 54 with the intermediate chute 58 leading to clamshell station one 58a. In some such embodiments, a servo motor or another actuator can move the rotary diverter chute 54 around a central axis to pre-set positions to selectively direct doughballs D into each of the intermediate chutes 58, 62, 66, 70, 74 and to the upper level clamshells 58a, 62a, 66a, 70a, and 74a. In the illustrated embodiment, the rotary diverter chute 54 is configured to rotate 360 degrees to access each of the intermediate chutes 58, 62, 66, 70, 74 and upper level clamshells 58a, 62a, 66a, 70a, 74a. However, in other embodiments, the rotary diverter chute may be controlled by any device capable of operating the rotary diverter chute 54 to allow for 360 degree rotation to the intermediate chutes and clamshells.

The photoeye 78 is configured to sense the doughballs D placed into the rotary diverter chute 54 from the flighted main conveyor 22. The photoeye 78 can trigger the rotary diverter chute 54 to move to the next intermediate chute and clamshell station upon filling a clamshell and receipt of another doughball D into the rotary diverter chute 54. The upper level clamshells 58a, 62a, 66a, 70a, 74a are positioned directly above the lower level clamshells 58b, 62b, 66b, 70b, 74b. Each of the upper level clamshells has a first shell halve 94 and a second shell halve 98. When a clamshell releases a doughball D, the first shell halve 94 and the second shell halve 98 move away from each other to allow the doughball D to drop to the lower level clamshell, or alternatively, into a spotter tray having a number of nozzles 102 positioned under the lower level clamshells 58b, 62b, 66b, 70b, 74b to receive doughballs D from corresponding ones of the lower level clamshells 58b, 62b, 66b, 70b, 74b and to guide the doughballs D out of the doughball placer module 26 and onto the press conveyor 30. In the illustrated embodiment of FIGS. 1-4, the lower level clamshells and the upper level clamshells are similarly constructed. In other embodiments, the upper and lower level clamshells can be differently constructed.

The lower level clamshell moves the first shell halve 94 and the second shell halve 98 to release the doughball D to a spotter tray. The spotter tray ensures the proper placement of the doughballs D onto the press conveyor 30. The clamshells are configured to hold the doughballs D until the press conveyor 30 is ready to receive more doughballs D. The doughball placer module 26 also includes an overflow chute 82. The overflow chute 82 is configured to receive doughballs D from the rotary diverter chute 54 in situations including, but not limited to, when the upper level clamshells are full or when the control system determines that the press conveyor is not ready to receive more doughballs D. The overflow chute 82 enables the proofer 14, checkweight module 18, and flighted main conveyor 22 to remain in operation by allowing the doughballs D to be diverted to an overflow bin without having to shut down the entire automatic doughball system 10 and/or slow down the doughball system 10. In some embodiments, the photo eye 78 or another sensor supported on the doughball placer module 26 can be operable to determine whether each doughball D has a desired characteristic, such as, for example, whether each doughball D is within a desired weight, has a desired shape, and/or is of a desired size. In some such embodiments, the over flowchute 82 and the diverter chute 54 can be operable to direct rejected doughballs D away from the clamshells.

In operation, the doughballs D are output from the proofer 14 onto the feed conveyor 34. In some embodiments, the feed conveyor 34 may move at approximately 60 feet/minute. However, in other embodiments, the feed conveyor 34 may move faster or slower accordingly to the desired overall output of the automatic doughball system 10. The feed conveyor 34 transfers the doughballs D to the checkweight module 18. At the checkweight module 18, the doughballs D enter the speed-up conveyor 38, which may increase or decrease the travel speed of individual doughballs D depending on the demands of the automatic doughball system 10 in order to keep the doughballs D separated for weighing and/or other downstream operations. The doughballs D then enter the checkweigher 42. The checkweigher 42 checks the weight of each doughball D to determine if each of the doughballs D is over or under a pre-determined weight range. For instance, if a doughball D is over a certain predetermined weight, it may indicate a double doughball D. If the doughball D does not fall within the specified weight range, the doughball D will be output from the system via a reject chute 46. The reject chute 46 may output the doughball D to a reject bin. In some embodiments, the dough in the reject bin may be re-used in future doughballs D.

When the doughball D falls with the specified weight range, the doughball D proceeds to the flighted main conveyor 22. The flighted main conveyor 22 separates each doughball D and conveys the doughballs D to the doughball placer module 26. As illustrated, the flighted main conveyer 22 is on an incline trending upward toward the doughball placer module 26. The flighted conveyor uses slots 50 to keep the doughballs D separated as the doughballs D proceed at an incline. In other embodiments, the flighted main conveyor 22 may be flat or may be at a decline. The flighted main conveyor 22 may be oriented at any angle dictated by the space in which the automatic doughball system 10 is placed.

As the doughballs D reach the top of the flighted main conveyor 22, the doughballs D are singly dropped into the rotary diverter chute 54. The rotary diverter chute 54 is aligned with the first intermediate chute 58 and clamshell station one 58a when the automatic doughball system 10 is initialized. The first doughball D is fed into the rotary diverter chute 54 from the flighted main conveyor 22 and through the intermediate chute 58 to upper level clamshell station one 58a. As the doughballs D drop off the end of the flighted main conveyer 22, the photoeye 78 senses the doughballs D and triggers the rotary diverter chute 54 to move to the next intermediate chute and clamshell station, in this case, to intermediate chute 62 and clamshell station two 62a. When upper level clamshell station one 58a receives the doughball D, upper level clamshell station one 58a immediately releases the doughball D to lower level clamshell station one 58b. This process continues throughout the upper level clamshells, filling each upper level clamshell station and proceeding from clamshell station one 58a to clamshell station two 62a to clamshell station three 66a to clamshell station four 70a to clamshell station five 74a and then returning to clamshell station one 58a. Upon receiving a doughball D, the upper level clamshell immediately releases the doughball D to the respective lower level clamshell.

The lower level clamshells retain the doughballs D until all of the lower level clamshells have been filled. Once all of the lower level clamshells are full, the lower level clamshells receive a signal from a controller (e.g., a microprocessor) that the press conveyor 30 is prepared to receive the doughballs D. The lower level clamshells then release the doughballs D simultaneously into the spotter tray and onto the press conveyor 30. In some such embodiments, all of the lower level clamshells release doughballs D within less than one-tenth of a second. In other embodiments, all of the lower level clamshells release doughballs D within less than one-half of a second.

The spotter tray ensures placement of the doughballs D into the proper location on the press conveyor 30 and ensures that a desired spacing is maintained between each doughball D on the press conveyor 30. The press conveyor 30 transports the doughballs D so that the doughballs D may be pressed and prepared for receiving the pizza toppings.

A controller keeps track of the clamshells containing a doughball D. The photoeye 78 continually senses the doughballs D in order to trigger the rotation of the rotary diverter chute 54 to each respective intermediate chute and clamshell station. The doughball placer module 26 is configured to hold the doughballs D in the lower level clamshells until all of the lower level clamshells are full at which time the lower level clamshells release the doughballs D. In the meantime, the upper level of clamshells receive the doughballs D from the rotary diverter chute and hold the doughballs D until the upper level clamshell receives a signal that its respective lower level clamshell is empty. The upper level clamshell will then release the doughball D to its respective lower level clamshell. The cycle of filling the clamshells and releasing the doughballs D continues as long as the controller signals for doughballs D and the doughball placer module 26 is operating.

In the event the press conveyor 30 is not operating at the required rate of production to handle the rate of doughballs D being delivered by the doughball placer module 26, the upper level clamshells and the lower level clamshells will become filled. When the upper level clamshells are filled with doughballs D, the upper level clamshells can no longer receive doughballs D until the doughballs D are released to the lower level clamshells. However, doughballs D are continually being processed through the proofer 14, checkweight module 18 and the flighted main conveyer 22, so the doughballs D are output from the flighted main conveyor 22 to the rotary diverter chute 54 which then aligns with the overflow chute 82 instead of aligning with an intermediate chute and clamshell station. The overflow chute 82 is configured to receive the doughballs D until the intermediate chutes and clamshell stations can again receive doughballs D. The overflow chute 82 allows the automatic doughball system 10 to continue operating without stopping. Once the press conveyor allows doughballs D to be dispensed from the lower level clamshells and the upper level clamshells resume releasing doughballs D to respective lower level clamshells, the rotary diverter chute 54 rotates away from the overflow chute 82 and aligns again with intermediate chute 58 and clamshell station one 58a.

The automatic doughball system is designed to handle even and uneven flow rates of doughballs D. In the event of an even flow rate of doughballs D, the upper level clamshells release doughballs D to the respective lower level clamshells, and the lower level clamshells release doughballs D to the press conveyor upon the filling of lower level clamshell station five with a doughball D. The process continues without resort to the overflow chute. However, in the event of an uneven flow of doughballs D, the upper level clamshells are utilized for accumulation of doughballs D at which point the rotary diverter chute 54 moves to the overflow chute 82 to dispose of additional doughballs D.

For normal operation, the doughball supply rate can be set slightly higher than the press cycle rate of the press conveyor 30. The number of clamshells filled in the level prior to dispensing to the lower level clamshells is based on the supply rate of both the doughballs D to the clamshells and the doughballs D from the clamshells to the press conveyor 30, as well as the steadiness of the flow rate.

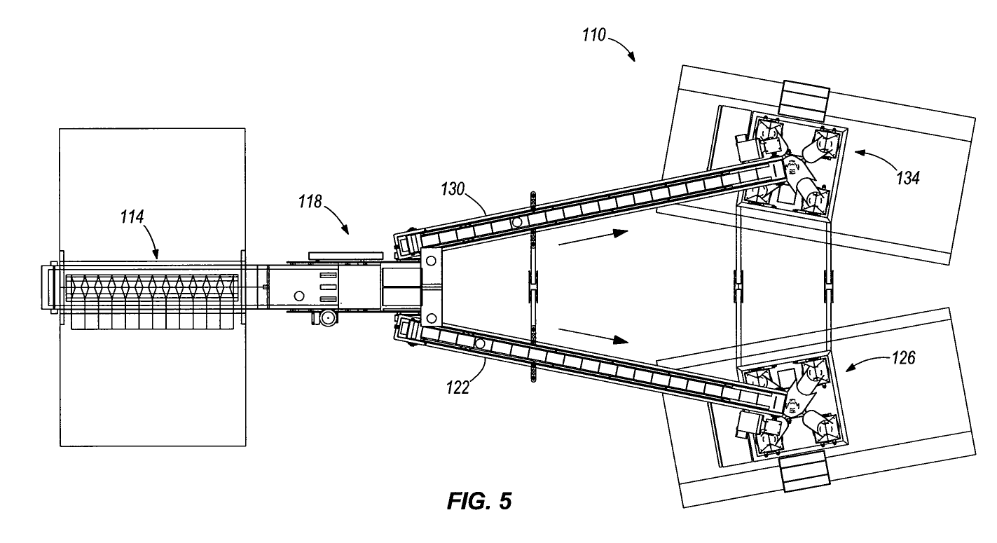

FIG. 5 illustrates an alternate embodiment of an automatic doughball system 110. FIG. 6 shows the automatic doughball system 110 having a proofer 114, a checkweight module 118, a right side flighted main conveyor 122, a right side doughball placer module 126, a left side flighted conveyor 130, and a left side doughball placer module 134. The right side and left side flighted main conveyors 122, 130 and right side and left side doughball placer modules 126, 134, respectively, allow for the processing of a greater volume of doughballs D.

In operation, when a doughball D exits the checkweight module 118, a diverter chute moves the doughball D onto either of the right side flighted main conveyor 122 or the left side flighted conveyor 130. The right side flighted main conveyor 122 and right side doughball placer module 126 can conduct the following operation and the left side flighted conveyor 130 and the left side doughball placer module 134 can operate in substantially the same manner at substantially the same time. The doughballs D exit the right side flighted main conveyor 122 and enter a centralized rotary diverter chute. The rotary diverter chute is configured to rotate 360 degrees and is controlled by a servo-motor. The rotary diverter chute fills a staging clamshell below each of four UP positions, where each of a first UP position, a second UP position, a third UP position, and a fourth UP position correspond to a first clamshell, a second clamshell, a third clamshell, and a fourth clamshell, respectively. There is also a position for overflow of doughballs D to a reject chute. Below the staging clamshells is a final drop clamshell which deposits the doughball D through an adjustable centering chute onto the press conveyor. The first clamshell, second clamshell, third clamshell, and fourth clamshell release the doughball D to the adjustable centering chute upon receipt of a doughball D. The adjustable centering chute ensures proper placement of the doughballs D on the press conveyor. If the press conveyor is not receiving doughballs D, the clamshells will hold a doughball D and additional doughballs D will be delivered by the rotary diverter chute to the overflow chute.

Either of the automatic doughball system 10 and the automatic doughball system 110 may be placed on a rail 178 to allow for movement of the system 10, 110 components.

In other embodiments, the automatic doughball system may have three, four or more flighted conveyors. The size and specifications of the automatic doughball system can be tailored to the applications and volume for which the automatic doughball system will be utilized. As such, it will be appreciated by one having ordinary skill in the art that various changes in the elements and their configuration and arrangement are possible without departing from the spirit and scope of the present invention as set forth in the appended claims.

For example, the main conveyor 22, the feed conveyor 34, and the speed-up conveyor 38 of the illustrated embodiment of FIGS. 1-4 are each belt-type conveyors. In other embodiments, one or more of the main conveyor 22, the feed conveyor 34, and the speed-up conveyor 38 can also or alternatively include a ramp, a sloped chute, a chain-conveyor, a paddle-wheel conveyor, and the like.

What is claimed is:

1. A dough dispensing system comprising:
a first plurality of dough receptacles;
a second plurality of dough receptacles, each one of the second plurality of dough receptacles positioned adjacent to a corresponding one of the first plurality of dough receptacles to receive dough from the corresponding one of the first plurality of dough receptacles; and
a diverter moveable relative to the first plurality of dough receptacles to direct the dough sequentially into each of the first plurality of dough receptacles;
wherein each of the second plurality of dough receptacles dispenses dough substantially simultaneously.

2. The dough dispensing system of claim 1, further comprising a sensor adjacent to the diverter and operable to record one of dough entering the diverter, dough supported in the diverter, and dough exiting the diverter, and wherein the sensor is operable to signal the diverter to move into alignment with an other of the first plurality of dough receptacles after recording the one of dough entering the diverter, dough supported in the diverter, and dough exiting the diverter.

3. The dough dispensing system of claim 1, wherein each of the first plurality of dough receptacles includes a clamshell having a pair of clamshell members moveable relative to one another to dispense dough.

4. The dough dispensing system of claim 3, wherein each of the second plurality of dough receptacles includes a clamshell having a pair of clamshell members moveable relative to one another to dispense dough.

5. The dough dispensing system of claim 1, further comprising an overflow chute adjacent to the first plurality of dough receptacles to receive at least one of rejected dough and dough when each of the first plurality of dough receptacles is unavailable to receive dough from the diverter.

6. The dough dispensing system of claim 5, wherein the diverter is moveable into selective alignment with each of the first plurality of dough receptacles and the overflow chute.

7. The dough dispensing system of claim 1, further comprising a plurality of nozzles positioned under the second plurality of dough receptacles, and wherein each of the plurality of nozzles is positioned adjacent to a corresponding one of the second plurality of dough receptacles to guide the dough out of the dough dispensing system.

8. The dough dispensing system of claim 1, wherein, after receiving dough from the diverter, at least one of the first plurality of dough receptacles empties the dough into a corresponding one of second plurality of dough receptacles substantially immediately.

9. The dough dispensing system of claim 1, further comprising a sensor positioned adjacent to the diverter to sense a characteristic of the dough prior to the dough entering any of the first plurality of dough receptacles.

10. The dough dispensing system of claim 1, wherein the diverter is moveable about a central axis to direct dough into each of the first plurality of dough receptacles, and wherein all but one of the first plurality of dough receptacles are arranged circumferentially around the central axis.

11. The dough dispensing system of claim 1, wherein at least one of the first plurality of dough receptacles receives dough while a corresponding one of the second plurality of dough receptacles also houses dough.

12. The dough dispensing system of claim 1, wherein at least one of the first plurality of dough receptacles receives dough when a corresponding receptacle of the second plurality of dough receptacles houses dough and an other receptacle of the second plurality of dough receptacles remains substantially free of dough.

13. The dough dispensing system of claim 12, wherein each of the first plurality of dough receptacles delay dispense of dough until a corresponding one of the second plurality of dough receptacles is substantially free of dough.

14. The dough dispensing system of claim 1, wherein the first plurality of dough receptacles are positioned above and in line with corresponding ones of the second plurality of dough receptacles.

15. A dough dispensing system comprising:
a diverter moveable about a central axis to direct dough into each of a first plurality of dough receptacles;
a second plurality of dough receptacles, each one of the second plurality of dough receptacles positioned adjacent to the first plurality of dough receptacles to receive dough from a corresponding one of the first plurality of dough receptacles; and
a sensor associated with the second plurality of dough receptacles to determine whether at least one of the second plurality of dough receptacles contains dough and operable to delay dispense of dough from a corresponding one of the first plurality of dough receptacles until the at least one of the second plurality of dough receptacles is substantially dough-free.

16. The dough dispensing system of claim 15, wherein each of the second plurality of dough receptacles dispenses dough substantially simultaneously.

17. The dough dispensing system of claim 15, further comprising a sensor adjacent to the diverter and operable to record a position of dough relative to the diverter, and wherein the sensor is operable to signal the diverter to move into alignment with an other of the first plurality of dough receptacles after recording the position of the dough relative to the diverter.

18. The dough dispensing system of claim 15, wherein at least one of the second plurality of dough receptacles includes a clamshell having a pair of clamshell members moveable relative to one another to dispense dough.

19. The dough dispensing system of claim 18, wherein at least one of the first plurality of dough receptacles includes a clamshell having a pair of clamshell members moveable relative to one another to dispense dough.

20. The dough dispensing system of claim 15, further comprising an overflow chute adjacent to the first plurality of dough receptacles to receive rejected dough or to receive dough when each of the first plurality of dough receptacles is unavailable to receive dough from the diverter.

21. The dough dispensing system of claim 20, wherein the diverter is moveable into selective alignment with each of the first plurality of dough receptacles and the overflow chute.

22. The dough dispensing system of claim 15, further comprising a plurality of nozzles positioned under corresponding ones of the second plurality of dough receptacles to guide the dough out of the dough dispensing system.

23. The dough dispensing system of claim 15, further comprising a sensor positioned adjacent to the diverter to sense a characteristic of dough exiting the diverter.

24. The dough dispensing system of claim 15, wherein all but one of the first plurality of dough receptacles are arranged circumferentially around the central axis.

25. The dough dispensing system of claim 15, wherein the second plurality of dough receptacles are positioned below the first plurality of dough receptacles.

26. A method of dispensing dough, the method comprising the acts of:
directing dough from a first plurality of dough receptacles to an adjacent second plurality of dough receptacles such that each one of the second plurality of dough receptacles receives dough from a corresponding one of the first plurality of dough receptacles;
holding dough in the second plurality of dough receptacles until each of the second plurality of dough receptacles receives dough; and
dispensing the dough from each of the second plurality of dough receptacles substantially simultaneously.

27. The method of claim 26, further comprising:
aligning a diverter with one of the first plurality of dough receptacles;
sensing one of a location of dough, dough entering the diverter, and dough exiting the diverter; and
signaling the diverter to move into alignment with an other of the first plurality of dough receptacles after recording the one of the location of dough, dough entering the diverter, and dough exiting the diverter.

28. The method of claim 26, wherein directing dough from the first plurality of dough receptacles to the adjacent second plurality of dough receptacles includes moving a pair of clamshell members relative to one another to dispense the dough.

29. The method of claim 26, wherein each of the second plurality of dough receptacles includes a clamshell having a pair of clamshell members, and wherein dispensing dough from the second plurality of dough receptacles includes moving each of the clamshell members relative to one another to dispense dough.

30. The method of claim 26, further comprising:
selectively aligning a diverter with each of the first plurality of dough receptacles; and
dispensing dough from the diverter to an overflow chute when either the dough is rejected or each of the first plurality of dough receptacles is unavailable to receive dough.

31. The method of claim 26, further comprising selectively aligning a diverter with each of the first plurality of dough receptacles and an overflow chute to dispense dough.

32. The method of claim 26, further comprising emptying dough from each of the second plurality of dough receptacles into a plurality of corresponding nozzles positioned under the second plurality of dough receptacles, the nozzles guiding the dough out of the dough dispensing system.

33. The method of claim 26, further comprising:
selectively aligning a diverter with each of the first plurality of dough receptacles to dispense dough; and
emptying each of the first plurality of dough receptacles substantially immediately after each of the dough receptacles receives dough from the diverter.

34. The method of claim 33, further comprising determining whether one of the second plurality of dough receptacles is empty prior to dispensing dough from a corresponding one of the first plurality of dough receptacles.

35. The method of claim 26, further comprising sensing a characteristic of dough prior to dispensing the dough to one of the first plurality of receptacles and directing dough not having a desired characteristic away from the first plurality of dough receptacles.

36. The method of claim 26, further comprising rotating a diverter about a central axis to selectively align the diverter with each of the first plurality of dough receptacles to dispense dough.

37. The method of claim 26, further comprising holding dough in one of the first plurality of dough receptacles when each of the second plurality of dough receptacles house dough.

38. The method of claim 26, further comprising determining whether at least one of the second plurality of dough receptacles is housing dough and delaying dispense of dough from a corresponding one of the first plurality of dough receptacles until the at least one of the second plurality of dough receptacles is free of dough.

39. The method of claim 26, wherein directing dough from the first plurality of dough receptacles to the adjacent second plurality of dough receptacles includes dropping dough from the first plurality of dough receptacles into corresponding ones of the second plurality of dough receptacles, which are positioned below and in line with the first plurality of dough receptacles.

40. The method of claim 26, further comprising:
aligning a diverter with one of the first plurality of dough receptacles;
sensing dough in the one of the first plurality of dough receptacles; and
moving the diverter into alignment with an other of the first plurality of dough receptacles to dispense the dough to an other of first plurality of dough receptacles.

42. The method of claim 27, further comprising:
selectively aligning a diverter with each of the first plurality of dough receptacles;
sensing a characteristic of dough to be dispensed by the diverter; and
moving the diverter relative to the first plurality of dough receptacles based on the sensed characteristic of the dough.

43. The method of claim 42, wherein moving the diverter relative to the first plurality of dough receptacles includes moving the diverter into alignment with an overflow chute when the characteristic of the dough is outside a desired range of the characteristic.
